(19) United States
(12) Patent Application Publication
(10) Pub. No.: US 2008/0165736 A1
(43) Pub. Date: Jul. 10, 2008

(54) Macro Diversity Handover and Fast Access Station Switching in Wireless Multi-User Multi-Hop Relay Networks

(76) Inventors: Shengjie Zhao, Medford, MA (US); Koon Hoo Teo, Lexington, MA (US); Zhifeng Tao, Allston, MA (US); Jinyun Zhang, Cambridge, MA (US)

Correspondence Address: MITSUBISHI ELECTRIC RESEARCH LABORATORIES, INC., 201 BROADWAY, 8TH FLOOR, CAMBRIDGE, MA, 02139, US

(21) Appl. No.: 11/620,322

(22) Filed: Jan. 5, 2007

(51) Int. Cl. H04Q 7/00

(52) U.S. Cl. 370/331

(57) ABSTRACT

Handover procedures and a collection of new handover MAC management messages are provided for a wireless mobile multi-bop relay (MMR) network. The types of handovers supported include macro diversity handover (MDHO) and fast access station switching (FASS). The handover procedures for these two types of handover and the MAC messages are described for nine main classes of network topologies. The nine classes of topology are further classified into to main categories, namely, intra multi-hop base station (MR-BS), when and where the handover is in the MMR cell, and inter MR-BS handover, when and where the handover is between two different MMR cells.

### FIELD OF THE INVENTION

This invention relates generally to wireless multi-user mobile networks, and in particular to wireless mobile multi-user, multi-hop networks.

### BACKGROUND OF THE INVENTION

IEEE Standards

The following standard specifications are incorporated herein by reference: “IEEE 802.16j Mobile Multihop Relay Project Authorization Request (PAR),” Official IEEE 802.16], March 2006, “IEEE Standard for Local and Metropolitan Area Networks—Part 16: Air Interface for Fixed Broadband Wireless Access Systems,” IEEE Computer Society and the IEEE Microwave Theory and Techniques Society, October 2004, and “IEEE Standard for Local and Metropolitan Area Networks—Part 16: Air Interface for Fixed Broadband Wireless Access Systems, Amendment 2: Physical and Medium Access Control Layers for Combined Fixed and Mobile Operation in Licensed Bands,” IEEE Computer Society and the IEEE Microwave Theory and Techniques Society, February 2006.

Definitions

The following terms are defined and used accordingly herein.

Base Station (BS) Equipment to provide wireless communication between subscriber equipment and an infrastructure or network backbone.

Multi-Hop Relay Base Station (MR-BS) A base station that is compliant with amendment IEEE Std 802.16j to IEEE Std 802.16, which has extended functionality to support a mobile, multi-hop (MMR) network.

Subscriber Station (SS) A generalized equipment set to provide communication between the subscriber equipment and the base station (BS).

Mobile Station (MS) A wireless transceiver intended to be used while in motion or at unspecified locations. The MS is always a subscriber station (SS) unless specifically specified otherwise.

Relay Station (RS) A wireless transceiver whose function is to relay data and control information between two or more stations, and to execute processes that support multi-hop communications.

Anchor Station A station where a MS or MRS is synchronized, performs ranging and monitors the downlink for control information. The anchor station can be a RS, BS, or MR-BS.

Fast Access Station Switching (FASS) Method by which an MS can change its access station from frame to frame depending on the station selection mechanism. The access station can be an RS, BS, or MR-BS. The MS is transmitting/receiving data to/from one of the active stations (the anchor station) during any given frame.

Macro Diversity Handover (MDHO) The process in which a mobile station (MS) migrates from the air-interface provided by one or more access stations to the air-interface provided by one or more other access stations. This process is accomplished in the downlink (DL) by having two or more access stations transmitting the same MAC/PHY protocol data unit (PDU) to the MS such that diversity combining can be performed by the MS. In the uplink (UL) it is accomplished by having two or more access stations receiving (demodulating, decoding) the same PDU from the MS, such that diversity combining of the received PDU can be performed among the access stations.

Active Station A station that is informed of the necessary MS or MRS MAC/PHY information to enable it to provide access to the MS or MRS in the context of macro diversity.

MMR Diversity Set The list of active stations of a given MS. This set is applicable to macro diversity handover, cooperative relay, and fast access station switching.

Serving Station For any MS, the serving station is the station with which the MS has most recently completed registration at initial entry into the network or during a handover. A serving station can be a BS or MR-BS.

Neighbor Station For any MS or RS, a neighbor station is a station (other than the anchor station) whose downlink transmission can be received by the MS or RS. A neighbor station can be a RS, BS, or MR-BS.

Target Access Station A station which is the primary candidate for MS network access following a handover. The target access station can be an RS, BS, or MR-BS.

Target Anchor Station For any MS or MRS, the station which is the primary candidate to be the anchor station following a handover. A target anchor station can be a RS, BS or MR-BS.

Target Serving Station A station which is the primary candidate for MS registration following a handover. The target serving station can be a BS or MR-BS.

Connection At a physical layer (PHY), a connection extends from an RF transmitter of a station, via one or more transmit antennas through a wireless channel, to an RF receiver of another station via one or more receive antennas. Physically, the connection communicates RF signals using a predetermined set of subchannels and time slots. At a logical layer, the portion of interest of the connection extends from a media access layer (MAC) of a protocol stack in the transmitter to the media access layer in the receiver. Logically, the connect ion caries the data and control information as a single bit stream.

Access Station The station at the point of direct access into the network for a given MS or RS. An access station can be a BS, RS, or MR-BS.

All other conventional acronyms used herein are define in the above IEEE standards, see also “Harmonized definitions and terminology for 802.16j Mobile Multihop Relay;” IEEE 802.16j-06/014r1, October 2006, and W. Stallings, “Data and Computer Communications.” Seventh edition, Prentice Hall, 2003, both incorporated herein by reference.

Handover Modes

According to the IEEE 802.16e standard, there are three basic modes of handover: Hard handover (HO), Fast BS Switching (FBSS), and Macro Diversity Handover (MDHO).

HO Mode

In the HO mode, the MS communicates, at any one time, with just one BS, which allows only low speed mobility, e.g., (portability or simple mobility). For higher speed mobility (full mobility) FBSS and MDHO provides better performance.

FBSS Mode

In FBSS, the data are sent to all BSs in the diversity active set, but without diversity combining. Further, the data are processed only in the anchor BS. This handover mode does not require explicit handover signaling messages when the anchor BS is changed. For FBSS, base stations (BS) use a fast switching mechanism to improve link quality. The mobile station (MS) is only transmitting/receiving data to or from one of the active BS, i.e., an anchor BS, at any given frame. The anchor BS can change from frame to frame depending on the base station (BS) selection scheme.

MDHO Mode

In the MDHO mode, the MS can communicate concurrently with all the BSs in a diversity active set. In the uplink (or downlink), BSs (MS) are capable of diversity combining of received signals. For MDHO mode, a mobile station (MS) migrates from the air-interface (channel) provided by one or more base station (BS)s to the air-interface provided by one or more other BSs. This is accomplished in the downlink (DL) by having two or more BSs transmitting the same MAC/PHY protocol data unit (PDU) to the MS such that diversity combining can be performed by the MS. In the uplink (UL), the migration is accomplished by having two or more BSs receiving (demodulating, decoding) the same PDU from the MS, such that diversity combining of the received PDU can be performed among the BSs.

FIG. 1 shows the MDHO according to the IEEE 802.16e standard, where a MS 101 can communicate directly and concurrently with multiple BSs 102. The network also includes a wired backbone or infrastructure 103. The backbone is not shown in the following Figures. Note, this conventional network does not include relay stations.

The above described the prior art for handover procedures between two or more base stations.

However in a mobile multi-hop relay (MMR) networks, user data and possibly control information is relayed from the MR-BS and MSs through one or more relay stations (RS).

The relay stations extend coverage, range, throughput, and a capacity of a MMR network, and enable very low power devices to participate in the network.

The adjective “mobile” as used herein refers to the fact that both mobile subscriber stations and mobile relay stations are supported. It may be possible to establish multiple communication paths between a multi-hop relay (MR)-BS and an MS and communicate the same user data and/or control information through both paths to improve performance.

It is desired to provide handover mechanisms for MMR networks.

### SUMMARY OF THE INVENTION

The embodiments of the invention provide handover procedures and MAC management messages to support the handover procedures for a mobile multi-hop relay (MMR) network. The handover procedures and the MAC management messages are described for nine classes of network topologies.

The MAC MDHO and PASS handover procedures and corresponding MAC management messages through relay stations are provided so that an IEEE 802.16e compliant mobile station can handover seamlessly within an IEEE 802.16j standard, or MMR network.

Because the network infrastructure includes the relay stations, nine different: MDHO and PASS handover cases can occur in the MMR network. The nine cases can be classified into two main categories of handover, namely;
(1) Intra MR-BS handover when the handover is in the same MMR cell; and
(2) inter MR-BS handover when the handover is between two different MMR cells.

### BRIEF DESCRIPTION OF THE DRAWINGS

FIG. 1 is a schematic of a prior art MDHO network without relay stations;

FIG. 2 is a schematic of intra MR-BS handover where the current anchor station and the target anchor station are the same MR-BS according to an embodiment of the invention;

FIG. 3 is a schematic of intra MR-BS handover, where the current anchor station is a RS and the target anchor station is its serving MR-BS according to an embodiment of the invention;

FIG. 4 is a schematic of intra MR-BS handover, where the current anchor station is a MR-BS, and the target anchor station is a RS in this MR cell according to embodiments of the invention;

FIG. 5 is a schematic of intra MR-BS handover, where the current anchor station and the target anchor station are the same RSs according to embodiments of the invention;

FIG. 6 is a schematic of intra MR-BS handover, where the current anchor station and the target anchor station are different RSs but in the same MR cell according to an embodiment of the invention;

FIG. 7 is a schematic of inter MR-BS handover, where the current anchor station and the target anchor station are different MR-BSs according to an embodiment of the invention;

FIG. 8 is a schematic of inter MR-BS handover, where the current anchor station is an MR-BS and the target anchor station is a RS controlled by a different MR-BS according to an embodiment of the invention;

FIG. 9 is a schematic of inter MR-BS handover, where the current anchor station is a RS and the target anchor station is a MR-BS in a different MR-cell according to an embodiment of the invention;

FIG. 10 is a schematic of inter MR-BS handover, where the current anchor station and the target anchor station are the different RSs located in different MR-eel Is according to an embodiment of the invention;

FIG. 11 is a timing diagram of messages for the macro diversity handover shown in FIG. 10;

FIG. 12 is a table of novel MAC management messages according to an embodiment of the invention; and

FIG. 13 is a flow diagram of a method for handing over according to an embodiment of the invention.

### DETAILED DESCRIPTION OF THE PREFERRED EMBODIMENTS

The embodiments of the invention provide methods for macro diversity handover and fast access station switching in a wireless multi-user, multi-hop relay network. Due to the relay stations in the network infrastructure, there are two main categories of MDHO or PASS handover.

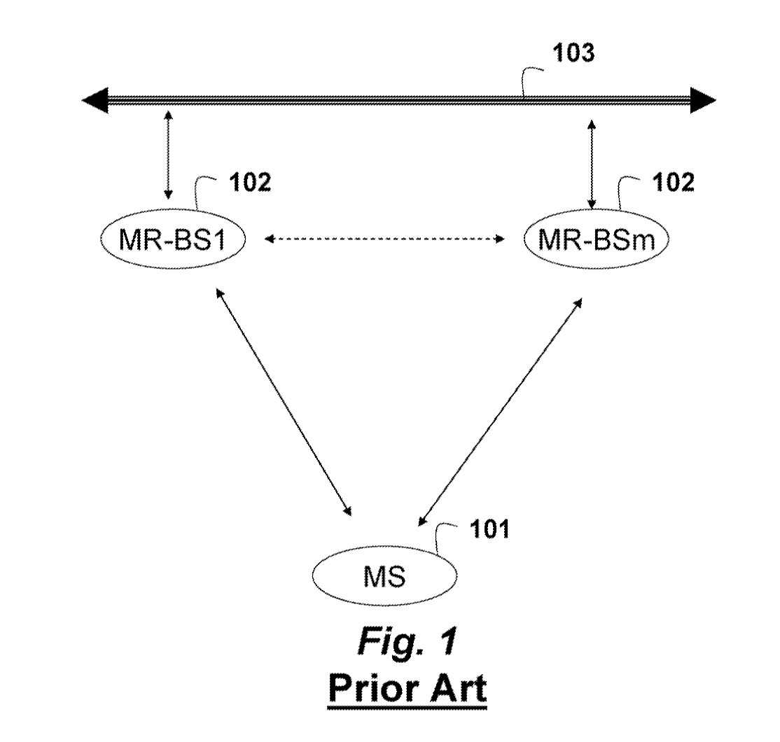

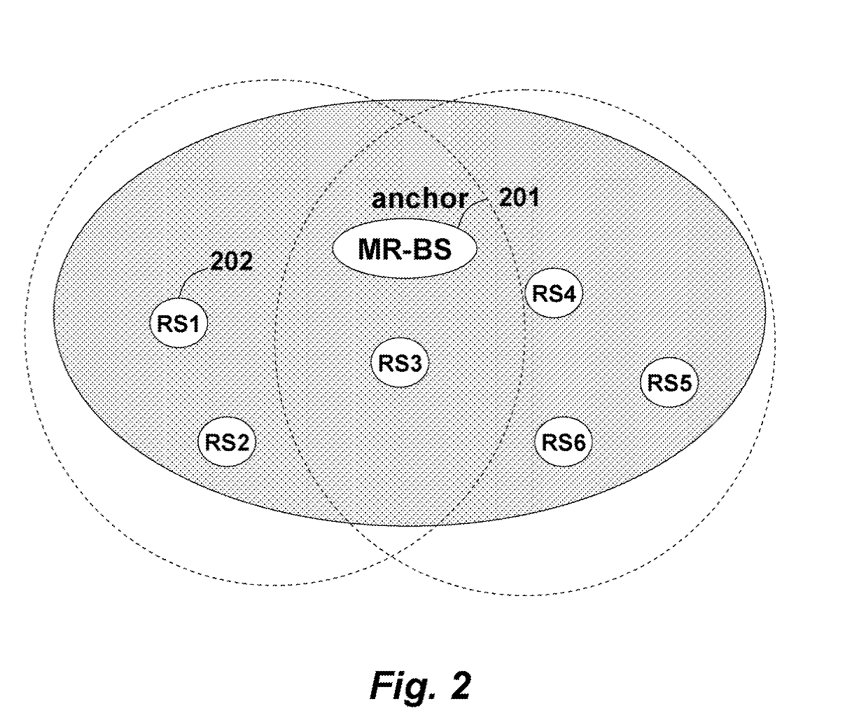

In the FIGS. 2-10, ovals indicate base station cells, circles relay station cells, and arrows handovers, generally. For clarity, the backbone 103 of FIG. 1 is not shown in FIGS. 2-10.

Intra MR-BS Handover

In intra MR-BS handover, a diversity set is updated among a set of RSs or the MR-BS controlled by the same serving MR-BS. This category includes five cases. As used herein a set of mobile, relay, or base stations can include one or more stations.

Case 1: the current anchor station and the target anchor station is MR-BS 201 communicating with the set relay stations (RS1-RS6) 202, as shown in FIG. 2.

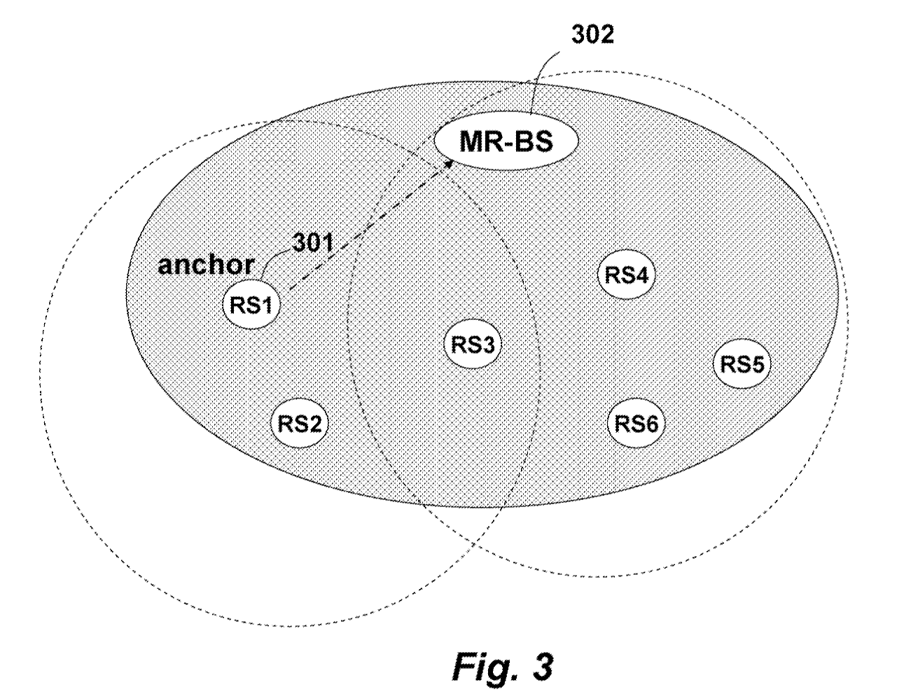

Case 2: the current anchor station is RS 301 and target anchor station is MR-BS 302, as shown in FIG. 3.

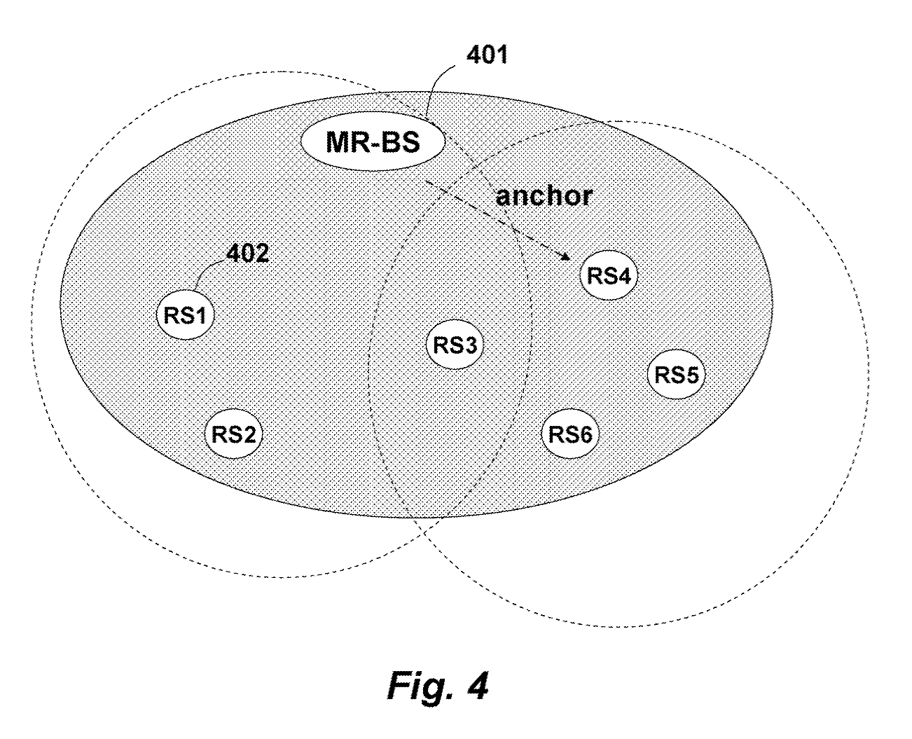

Case 3; the current anchor station is MR-BS 401 and the target anchor station is RS 402, as shown in FIG. 4

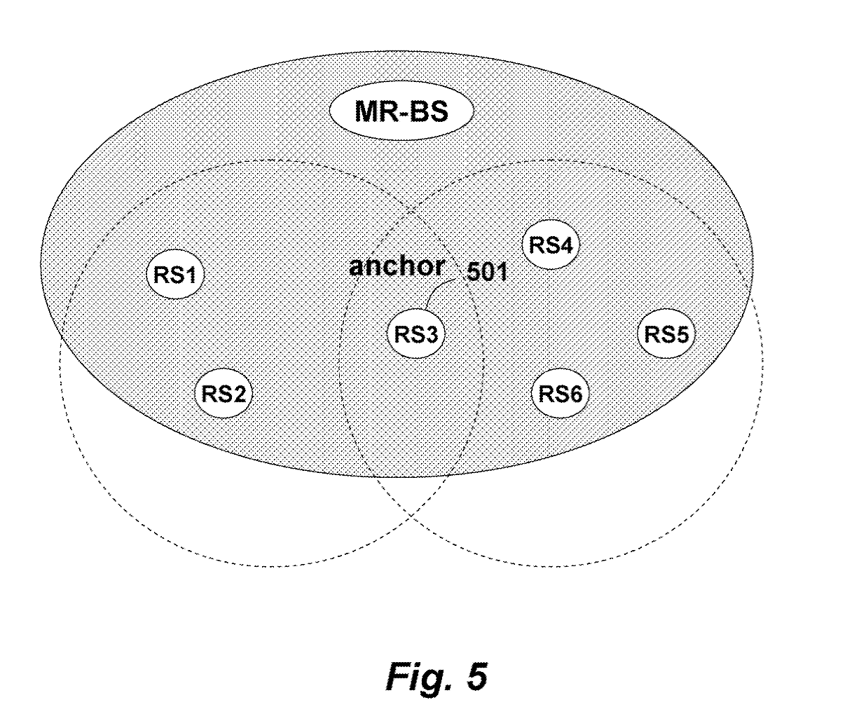

Case 4: the current anchor station and the target anchor station is the same RS 501, as shown in FIG. 5.

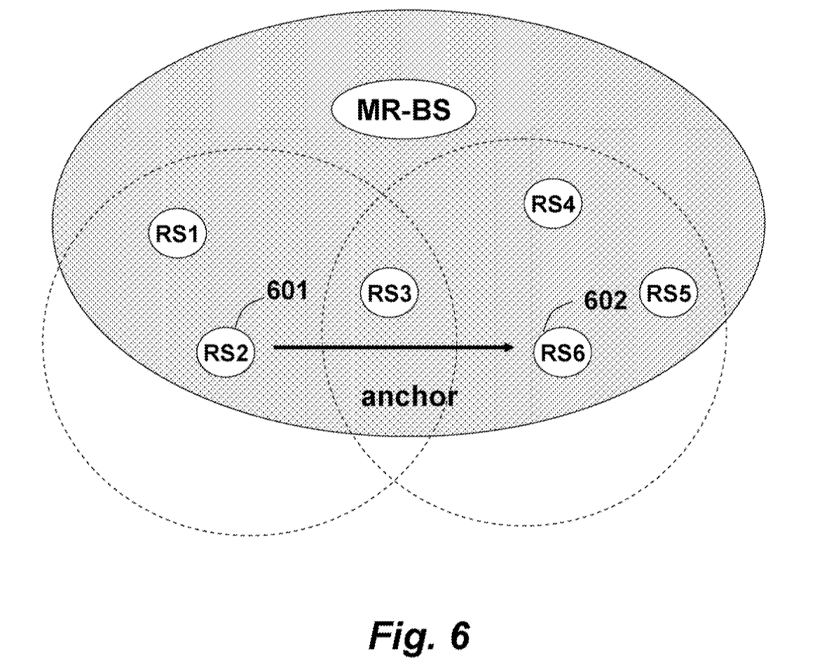

Case 5: the current anchor station and the target anchor station is the different RSs 601-602, as shown in FIG. 6.

Inter MR-BS Handover

In inter MR-BS handover, the diversity set is updated, among a set of RSs controlled by a set of MR-BSs. This category includes four cases.

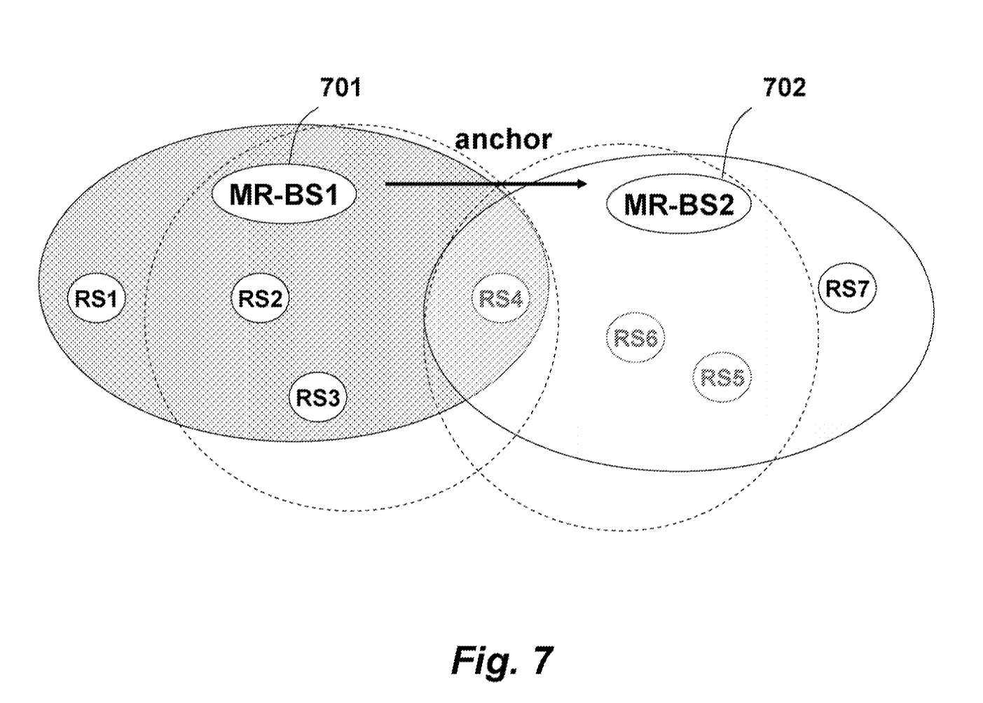

Case 6: the current anchor station and the target anchor station are different MR-BSs 701-702, as shown in FIG. 7.

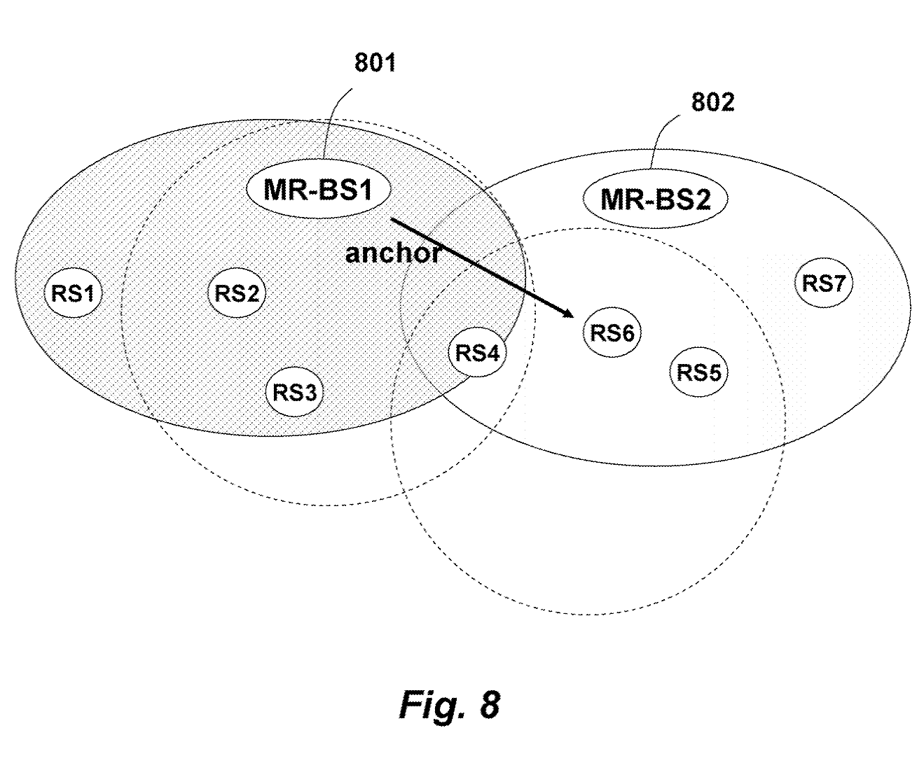

Case 7: the current anchor station is a MR-BS and the target anchor station is a RS controlled by the different: MR-BS 801-802, as shown in FIG. 8.

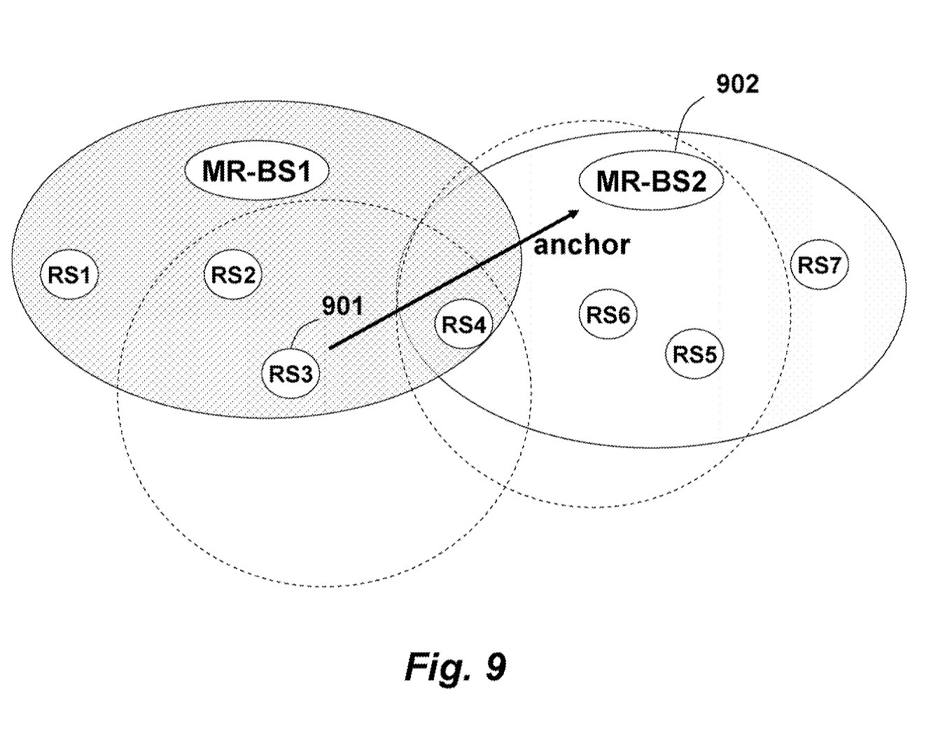

Case 8; the current anchor station is a RS 901 and the target anchor station is a MR-BS 902 in a different MR-cell, as shown in FIG. 9.

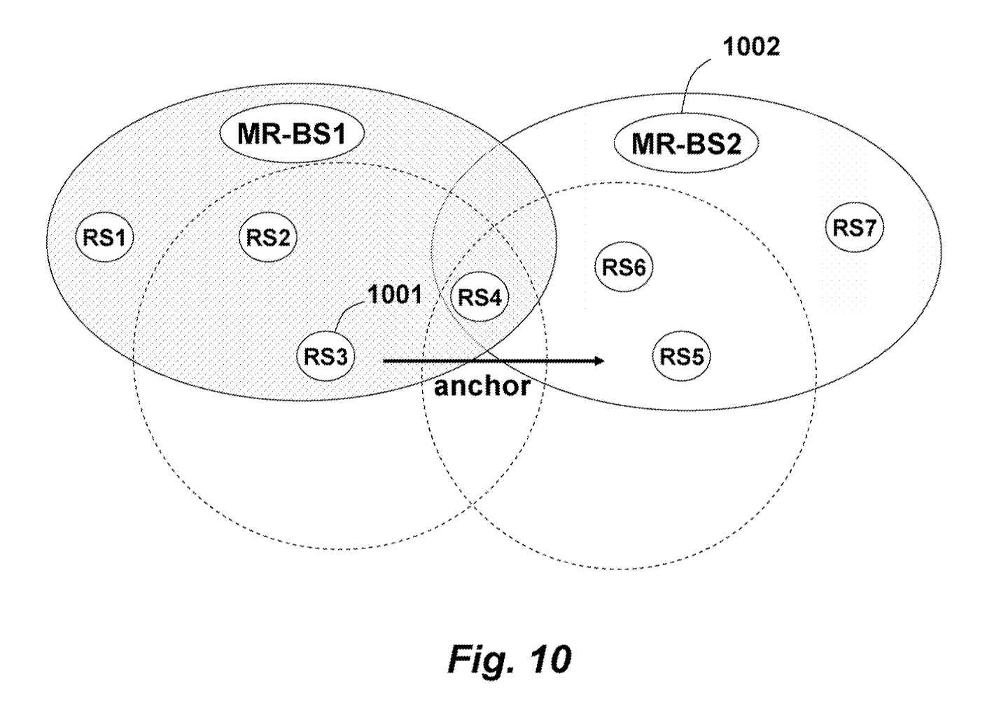

Case 9: the current anchor station and the target anchor station are different RSs and are located in different: MR-cells, as shown in FIG. 10.

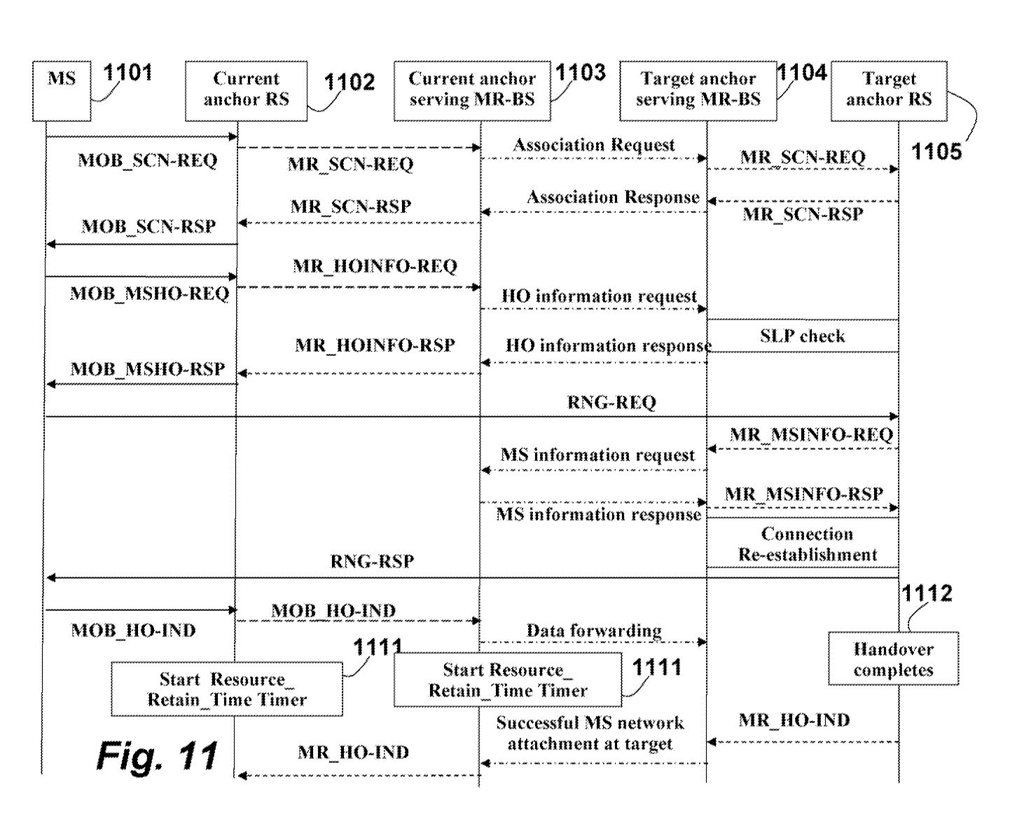

FIG. 11 shows an example MDHO/FASS handover procedures for case 9 as shown an described for FIG. 10. In FIG. 11, the arrows show the directions of the messages. FIG. 11 shows the MS 1101, the current anchor RS 1102, the current anchor serving MR-BS 1103, the target serving MR-BS 1104, and the target anchor RS 1105. Also shown is the start Resource_Retain_Time timers 1111, and the completion of handover 1112.

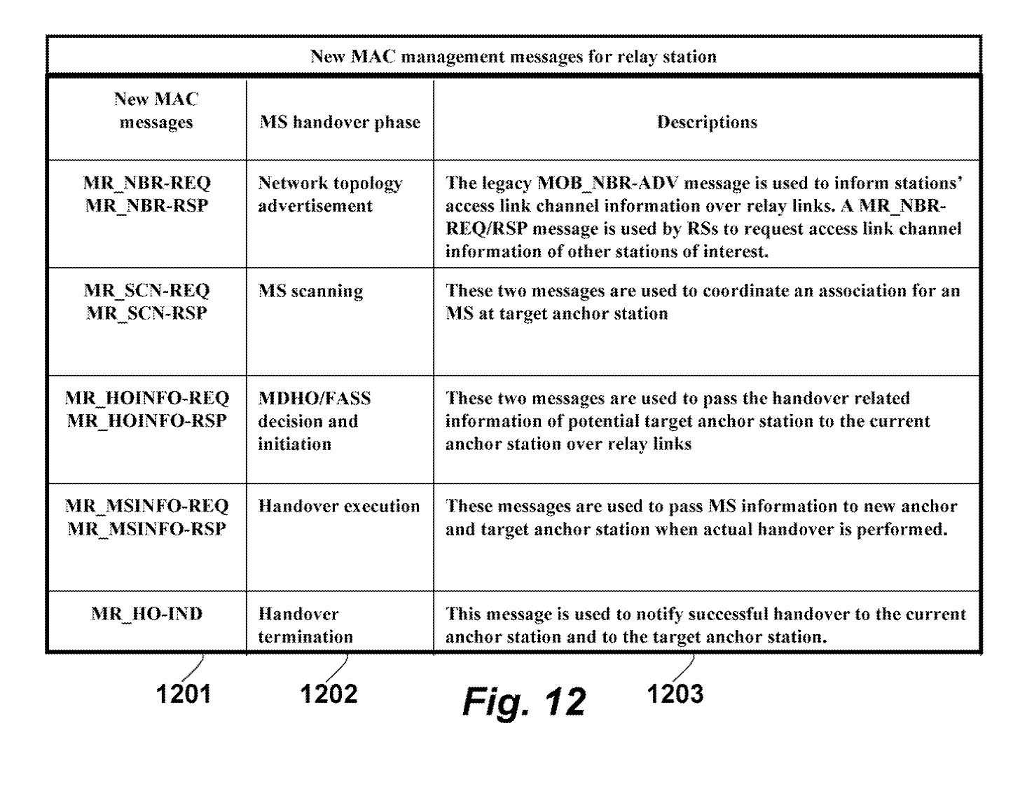

FIG. 12 shows a table of the novel MAC management messages according to the embodiments of the invention for stations in a network for each phase of a IEEE 802.16e compliant MS MAC handover procedure as shown in FIG. 10. The new MAC messages are named in column 1201, the phases are in column 1202, and the descriptions of the messages are in column 1203.

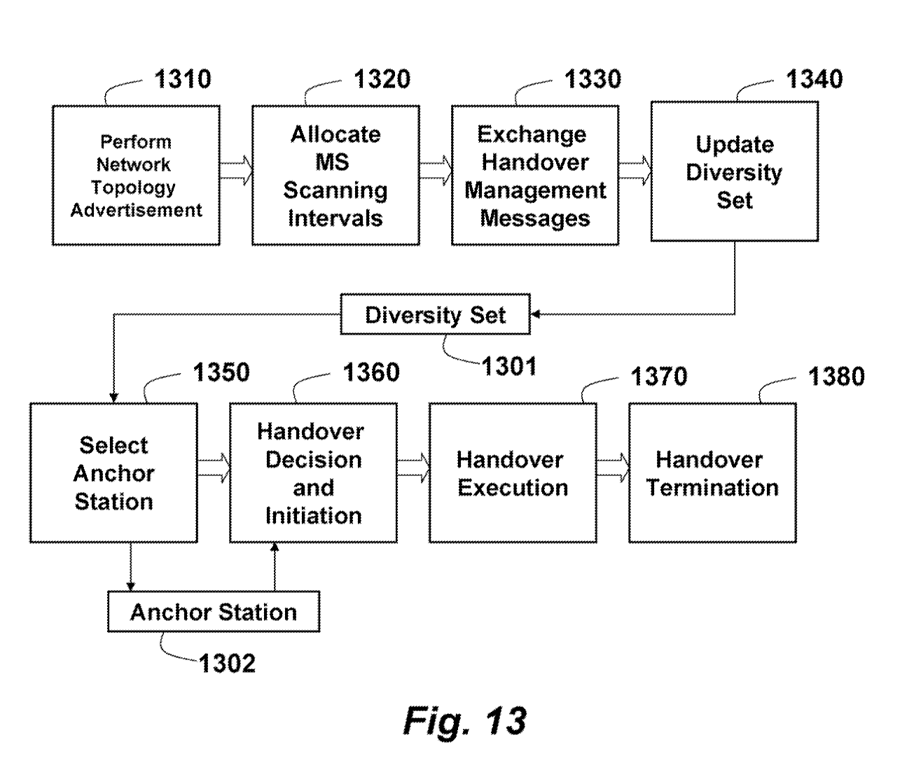

FIG. 13 shows a general method for macro diversity handover and fast access station switching in a wireless multi-user, multi-hop relay network according to an embodiment of the invention, described in detail below.

The signaling between the stations occurs over the wireless relay links (channels) as well as over the wired “backbone” or network infrastructure as known in the art.

Handover procedure can depend on the coordination between the MR-BS and the subordinate RSs with regards to broadcast control messages such as preamble, FCH, DL-MAP, UL-MAP, DCD and UCD message, as defined in the IEEE 802.16 standards incorporated herein by reference.

In a synchronous broadcast system, only the MR-BS transmits all the broadcast control messages, or the RSs in the same MR-cell forward the same broadcast control messages to the MSs.

In the asynchronous broadcast system, the RS can transmit its own preamble, FCH, DL-MAP, UL-MAP, DCD, and UCD messages. The embodiments of the invention provide the MDHO handover and FASS handover in a MR-cell network, and defines the MAC handover procedure for an asynchronous broadcast system.

The MAC handover procedure and MAC messages enable IEEE 802.16e compliant MSs to handover seamlessly following the handover procedure defined in subclause 6.3.22 of the IEEE 802.16e-2005 standard.

Macro Diversity Handover and Fast Access Station Switching

As shown in FIG. 13, the general method performs 1310 network topology advertisement. This step is described in further detail below. This is followed by allocating 1320 scanning intervals to the MSs, as described below.

The MDHO or PASS capability can be enabled or disabled by exchanging 1330 handover MAC management messages as shown in FIG. 11. The messages are defined in FIG. 12. With MDHO or PASS enabled, the MS performs the following stages.

MDHO Decision: A MDHO begins with a decision by an MS to concurrently transmit to and receive from multiple MR-BS and/or RSs. The MDHO can start with and exchange of handover management messages. The handover management message can be either a MOB_MSHO-REQ message by the MS or a MOB_BSHO-REQ message by the anchor station.

FASS Decision: A FASS handover begins with a decision for an MS to receive or transmit data from or to the anchor station that may change within the diversity set. A PASS handover is also initiated with and exchange of the handover management messages, which can by either the MOB_MSHO-REQ message by the MS, or the MOB_BSHO-REQ message by the anchor station.

Anchor Station Update/Selection; An MS monitors continuously the signal strength of the stations that are included in its diversity set 1301, and updates 1340 the diversity set accordingly by adding or deleting stations. Then the MS selects 1350 one station from its current: diversity set 1301 to be the anchor station, and signals the selected anchor station in CQICH or MOB_MSHO-REQ messages. Typically, the selected station is the one with the best signal strength.

The MR-BS or RS supporting MDHO or PASS broadcasts the DCD message that includes the H_Add Threshold and H_Delete Threshold. These thresholds are used by the FASS/MDHO capable MS to determine if the MOB_MSHO-REQ message should be sent.

If the long terra carrier to interference plus noise ratio (CINR) of an anchor station is less than a predetermined threshold H_Delete Threshold, then the MS sends the MOB_MSHO-REQ message to request the dropping of this anchor station from the diversity set. If the long-term CINR of a neighbor MR-BS or RS is greater than a predetermined threshold H_Add Threshold, then the MS sends the MOB_MSHO-REQ message to request the adding of this neighbor MR-BS or RS to the diversity set.

As defined in the IEEE 802.16e-2005 standard, MOB_BSHO-REQ and MOB_BSHO-RSP messages include the following information about possible target access stations for a particular MS: service level prediction; preamble index/subchannel index; HO process optimization; network assisted HO supported; and HO_authorization policy support.

This information can obtained over the backbone 103 in IEEE802.16e network, see FIG. 1. However, the information can also obtained over the relay links.

Therefore, we define two new handover MAC management messages, MR_HOINFO-REQ and MR_HOINFO-RSP, to exchange the information about the potential stations to be included in the diversity set.

Diversity Set Update for MDHO/FBSS

When the MOB_MSHO-REQ message is sent by an MS, the MS may provide a possible list of MR-BSs and/or RSs to be included in the diversity set of an MS. The MS may evaluate the possible list of MR-BSs and/or RSs through the received MOB_NBR-ADV message, and previously performed signal strength measurement, propagation delay measurement, scanning, ranging, and association activity.

When the MOB_BSHO-RSP message is sent by the anchor station in the current diversity set of the MS, the MR-BSs may provide a list of MR-BSs or RSs recommended for incorporation into the diversity set of the MS.

An MS and the potential stations in the diversity set conducts ranging by exchanging RNG-REQ and RNG-RSP message. An MS can indicates a handover attempt by sending a RNG-REQ message, which includes a station ID TLV, and sets the bit number of the ranging purpose indication TLV set to 1.

Upon receiving such a RNG-REQ message, the potential stations may request the MS for information, if the station has not yet received. Because the MS information may need to be obtained over the relay links, as well as over the backbone, we define two new handover MAC management messages MR_MSINFO-REQ and MR_MSINFO-RSF for informing the MS information.

Based MDHO/FASS Decision and Initiation

Based on the above information, a station can decide to handover and initiate the handover in step 1360.

MDHO/FBSS Handover Execution and Termination

Following initiation, the handover is executed 1370, and if successful terminated 1380. According to the IEEE 802.16e-2005 standard, the successful MS network attachment at the diversity set is informed by the previous anchor BS, over the network backbone. However in the IEEE 802.16j standard, this attachment: may be informed over the relay links, as well as the backbone.

Therefore, we describe a new handover MAC management message MR_HO-IND. This information is used to inform the previous anchor station of the successful MS network attachment at a new anchor MR-BS and/or RS.

Network Topology Advertisement

This section describes additions and modifications to the network topology advertisement procedure 1310, and the MS scanning procedure 1320 according to the embodiments of the invention for the current standards.

An MR-BS or RS periodically broadcasts a MOB_NBR-ADV message to all MSs that are in its cell. The MOB_NBR-ADV message includes access link channel information of other stations. The information may be obtained over wireless relay links, as well as the backbone in an MR network. Therefore, we define a new handover MAC management message MR_NBR-REQ for the information exchange over wireless relay links between MR-BS and RS, or between RS and RS, as shown in Table 1.

The new MR_NBR-RSP message may be defined for the response of the MR_NBR-REQ messages. The access station prepares a MOB_NBR-ADV message based on the information collected form the received MR_NBR-REQ messages. Then, the access station transmits the MOB_NBR-ADV messages to its associated MSs.

MR_NBR-REQ message is used by an RS or MR-BS to make a request of access channel information of other stations to tire serving MR-BS or upstream RS. The CID encoded in the general MAC header is the primary CID between an RS and an MR-BS, or between the requesting RS and its upstream RS.

TABLE 1

| Syntax | Size (bits) | Notes |
|---|---|---|
| MR_NBR- | — | — |
| REQ_Message_format( ) { | | |
| Management message type = TBD | TBD | |
| N_Stations | | Number of stations |
| | | for requesting the |
| | | channel information |
| For (i=0;i<N_Stations; i++) { | | |
| Station ID | 48 | |
| Padding | TBD | |
| } | | |
| } | | |

MS Scanning

An access station may allocate scanning intervals to an MS seeking and monitoring suitability of a potential target access station for a handover. As defined in IEEE 802.16e-2005, an MS may request an allocation of scanning intervals and a certain type of association with each potential target access station using a MOB_SCN-REQ message. In IEEE 802.16e-2005, three association levels: Association Level 0, Association Level 1, and Association Level 2, are defined. The requested association level is encoded in the scanning type field of the MOB_SCN-REQ message. Upon receiving a MOB_SCN-REQ message, the access station responds with a MOB_SCN-RSP message, in IEEE 802.16e-2005, coordination between BSs can be achieved over backbone. However the coordination needs to occur over the relay links as well as the backbone in 802.16j networks. We define two new handover MAC management messages MR_SCN-REQ and MR_SCN-RSP for the coordination over relay links, see Tables 2 and 3. A current access station send messages MR_SCN-REQ message to negotiate the association level with a upstream relay station, or even MR-BS to allocate the appropriate scanning intervals to the MSs.

TABLE 2

| Syntax | Size (bits) | Notes |
|---|---|---|
| MR_SCN-REQ_Message_format ( ) { | — | — |
| Management Message Type = TBD | TBD | |
| N_recommended_station | TBD | |
| For(i=0; | | |
| i<N_recommended_station;i++) { | | |
| Recommended Station ID | 48 | |
| Recommended Type | 3 | |
| } | | |
| Current access station ID | 48 | |
| Current MS ID | 48 | |
| Padding | TBD | Padding to reach |
| | | byte boundary |
| } | | |
| MR_SCN- | | |
| REQ_Message_format ( ) { | | |
| Management Message Type = | TBD | |
| TBD | | |
| N_recommended_station | TBD | |
| For(i<0; | | |
| i<N_recommended_station;i++){ | | |
| Recommended station ID | 48 | |
| Scanning Type | 3 | |
| If(scanning type.0) { | | |
| Rendezvous time | 8 | |
| CDMA code | 8 | |
| Transmission opportunity offset | 8 | |
| } | | |
| } | | |
| Current access station ID | 48 | |
| Associated MS ID | 48 | |
| Padding | TBD | Padding to reach |
| | | byte boundary |
| } | | |

Although the invention has been described by way of examples of preferred embodiments, it is to be understood that various other adaptations and modifications may be made within the spirit and scope of the invention. Therefore, it is the object of the appended claims to cover all such variations and modifications as come within the true spirit and scope of the invention.

We claim:

1. A method for macro diversity handover (MDHO) and fast access station switching (FASS) for a mobile station, and relay and base stations in a wireless multi-user multi-hop relay network, comprising the steps of:
performing network topology advertisement for the mobile station and the relay and base stations;
allocating scanning intervals to the mobile station according to the network topology advertisement;
exchanging handover management messages between the mobile station and the relay and base stations;
updating a diversity set for the mobile station communicating with a current anchor station;
selecting a target anchor station from the updated diversity set; and
handing the mobile station over from the current anchor station to the target anchor station.

2. The method of claim 1, in which the handover management messages are defined at a media access (MAC) layer of the network.

3. The method of claim 2, in which the handover management messages enable the MDHO and the FASS.

4. The method of claim 1, further comprising:
communicating user data between the mobile station and the relay and base stations.

5. The method of claim 3, in which during the MDHO, the mobile station migrates from an air-interface provided by one or more access stations to the air-interface provided by one or more other access stations.

6. The method of claim 3, in which during the FASS, the mobile station communicates user data with access stations, and the user data are communicated as frames, and the mobile station changes access stations from frame to frame depending on a station selection mechanism.

7. The method of claim 6, in which the mobile station communicates the user data from one a set of active stations during any particular frame.

8. The method of claim 1, in which the handover is within one cell of the network.

9. The method of claim 1, in which the handover is between different cells of the network.

10. The method of claim 8, in which the current anchor station and the target anchor station is a particular multi-hop relay base station.

11. The method of claim 8, in which the current anchor station is a particular relay station and the target anchor station is a particular multi-hop relay base station.

12. The method of claim 8, in which the current anchor station is a particular multi-hop relay base station and the target anchor station is a particular relay station.

13. The method of claim 8, in which the current anchor station and the target anchor station is a particular relay station.

14. The method of claim 8, in which the current anchor station and the target anchor are different relays stations.

15. The method of claim 9, in which the current anchor station and the target anchor station are different particular multi-hop relay base stations.

16. The method of claim 9, in which the current anchor station is particular multi-hop relay base station and the target anchor station is a particular relay station controlled by a different multi-hop relay base station.

17. The method of claim 9, in which the current anchor station is a particular relay station in one cell and the target anchor station is particular multi-hop relay base station in a different cell.

18. The method of claim 9, in which the current anchor station and the target anchor station are different relay stations in different cells.

19. The method of claim 1, in which the handover management messages comprise a message for performing the advertisement.

20. The method of claim 1, in which the handover management messages comprise a multi-hop scanning interval allocation request message.

21. The method of claim 1, in which the handover management messages comprise a multi-hop handover information request message,

22. The method of claim 1, in which the handover management messages comprise a multi-hop mobile station channel information request message.

23. The method of claim 1, in which the handover management messages comprise a multi-hop handover indication message.
